(19) United States
(12) Patent Application Publication
(10) Pub. No.: US 2021/0408957 A1
(43) Pub. Date: Dec. 30, 2021

(54) OVERVOLTAGE PROTECTION FOR ELECTRIC MOTOR DRIVERS

(71) Applicant: Hewlett-Packard Development Company, L.P., Spring, TX (US)

(72) Inventors: Roger Bastardas Puigoriol, Sant Cugat del Valles (ES); Oriol Antoli Sarrau, Sant Cugat del Valles (ES); Jordi Hernandez Creus, Sant Cugat del Valles (ES)

(73) Assignee: Hewlett-Packard Development Company, L.P., Spring, TX (US)

(21) Appl. No.: 17/259,583

(22) PCT Filed: Mar. 19, 2019
(86) PCT No.: PCT/US2019/022947

§ 371 Date: Jan. 12, 2021

(51) Int. Cl. H02P 29/024; H02P 3/04; H02P 29/028; B41J 29/38

(52) U.S. Cl. CPC H02P 29/0241; B41J 29/38; H02P 29/028; H02P 3/04

(57) ABSTRACT

Disclosed herein is an electric motor control circuit, a printing device, and a method of overvoltage protection for an electric motor. The electric motor control circuit comprises a controller, a voltage converter to generate a supply voltage of the controller from a voltage at terminals of the electric motor and a switchable braking circuit connected to the motor terminals. The controller is to activate the braking circuit if the voltage at the motor terminals exceeds a threshold voltage while the controller is in an off-state.

### BACKGROUND

Printing devices rely on electric motors for a variety of tasks, e.g. advancing a print medium or moving a print head. An electric motor may comprise sensitive control electronics, which may require protection to avoid damage e.g. due to an overvoltage.

### BRIEF DESCRIPTION OF DRAWINGS

In the following, a detailed description of various examples is given with reference to the figures. The figures show schematic illustrations of

FIG. 1: an electric motor control circuit in accordance with an example;

FIG. 2: a flow chart of a method of overvoltage protection for an electric motor according to an example;

FIG. 3: an electric motor control circuit with a motor driver according to an example;

FIG. 4: a flow chart of a method of overvoltage protection for an electric motor in accordance with an example;

FIG. 5a: a diagram of the angular velocity of an electric motor according to an example;

FIG. 5b: a diagram of the induced voltage of the electric motor in the example of FIG. 5a;

FIG. 5c: a diagram of the state of the motor driver of the electric motor in the example of FIG. 5a;

FIG. 6: a schematic sectional view of a printing device with an electric motor and a control circuit in accordance with an example; and

FIG. 7: a perspective view of a printing device according to an example.

### DETAILED DESCRIPTION

If an electric motor is rotated manually, the motor may act as a generator and the rotation of the electric motor can induce a voltage between terminals of the motor. The induced voltage may be higher than a driving voltage used to operate the motor and may damage sensitive motor electronics, e.g. a motor driver. In printing devices, this may for example occur when a user pulls on a print medium supplied to the printing device and thereby rotates the motor used to advance the print medium. To prevent damage to the motor electronics, a control circuit may be used to monitor the induced voltage and to implement safety measures before the induced voltage reaches a level that may cause damage on electronic components.

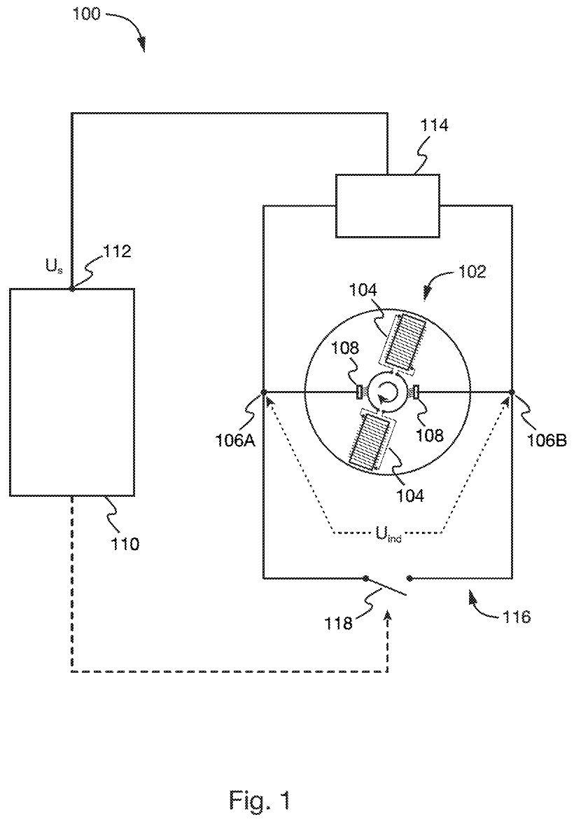

FIG. 1 depicts a control circuit 100 for an electric motor 102 in accordance with an example. In the example shown in FIG. 1, the electric motor 102 is a brushed DC motor comprising two coils 104. The coils 104 are connected to two motor terminals 106A and 106B via commutator brushes 108, which are to commute the polarity of a DC driving signal applied to the motor terminals 106A, 106B in order to drive the electric motor 102. In other examples, the electric motor 102 may comprise a different number of coils or motor terminals or may for example be a brushless DC motor or an AC motor.

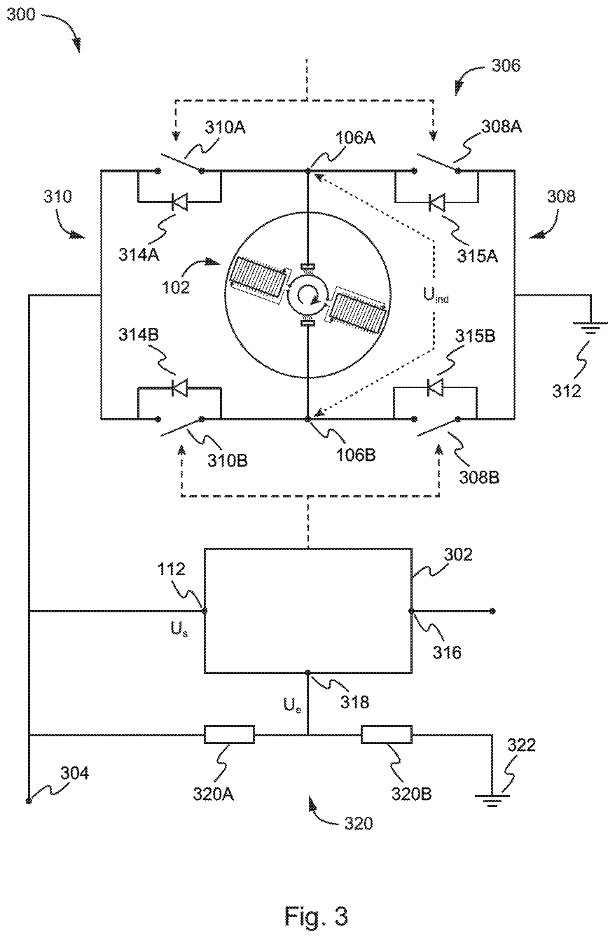

The control circuit 100 includes a controller 110, which may for example comprise a microprocessor, an analog electronic circuit, a digital electronic circuit or a combination thereof. In some examples, the controller 110 may be a motor driver that is to generate an electric driving signal for the electric motor 102, e.g. as described below with reference to FIG. 3. The controller 110 may have a supply voltage input 112 and may use a supply voltage Uₛ to operate, e.g. a DC supply voltage. The controller 110 may for example use a DC voltage equal to or larger than a minimum supply voltage to operate, i.e. the minimum supply voltage is the minimum voltage required by the controller 110 to operate. The minimum supply voltage may e.g. be a voltage in the range between 5 V and 30 V, for example 12 V or 15 V. The controller 110 may switch off if the supply voltage Uₛ is below the minimum supply voltage and may switch on if the supply voltage Uₛ is at or above the minimum supply voltage. In some examples, the supply voltage input 112 may also be connected to an external power supply (not shown in FIG. 1), which may provide the supply voltage Uₛ when the power supply is switched on.

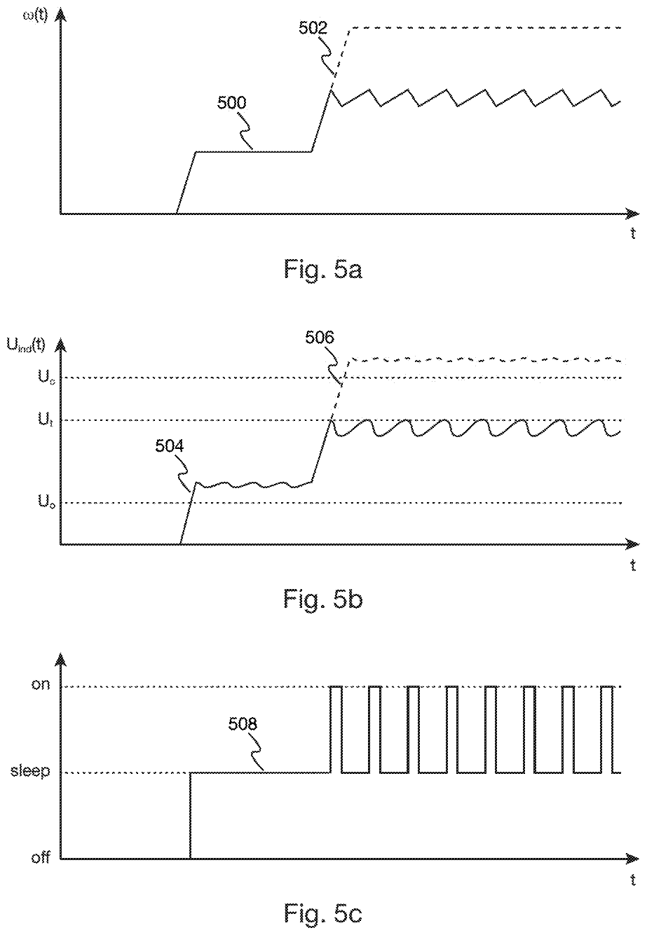

The control circuit 100 further comprises a voltage converter 114. The voltage converter 114 is to generate a supply voltage Uₛ of the controller 110 from a voltage U_{ind} at the motor terminals 106A, 106B, i.e. to convert the voltage at the terminals 106A, 106B to a voltage to power the controller 110. Accordingly, the supply voltage Uₛ may depend on the voltage U_{ind} at the motor terminals 106A, 106B and may be above the minimum supply voltage if the voltage U_{ind} at the terminals 106A, 106B exceeds a certain level as described below in more detail with reference to FIGS. 5a-5c. The voltage U_{ind} at the motor terminals 106A, 106B, in the following also referred to as terminal voltage U_{ind}, may for example be the voltage between the terminal 106A and the terminal 106B as shown in FIG. 1 or the voltage between at least one of the terminals 106A, 106B and a reference point, e.g. a ground contact. The terminal voltage U_{ind} may for example be a voltage induced by rotation of the electric motor 102. This may allow for operating the controller 110 without requiring an external power supply or when the external power supply is switched off or disconnected from power.

In some examples, the controller 110 may be provided with a supply voltage Uₛ with a certain polarity, e.g. a positive DC voltage. The terminal voltage U_{ind} may have a positive or negative polarity, which additionally may change over time. For a brushed DC motor, if the terminal voltage U_{ind} is induced by the motor 102, the polarity of the terminal voltage U_{ind} may e.g. depend on the direction in which the motor 102 rotates. For a brushless DC motor or an AC motor, the induced voltage may be an AC voltage with a periodically changing polarity. To generate the supply voltage Uₛ from the terminal voltage U_{ind}, the voltage converter 114 may comprise a rectifier between the terminals 106A, 106B and the supply voltage input 112. The rectifier may convert the terminal voltage U_{ind} to a supply voltage Uₛ with a predefined polarity at the supply voltage input 112. The rectifier may for example comprise a diode, e.g. as described below with reference to FIG. 3.

The voltage converter 114 may further comprise a smoothing circuit to stabilize the supply voltage Uₛ. The terminal voltage U_{ind} may vary over time and, depending on the design of the motor 102, may e.g. exhibit oscillations or ripples. The smoothing circuit may for example comprise a low-pass filter to suppress the fluctuations, e.g. a capacitor or a first order RC filter, or a voltage regulator. This may allow for providing a constant or almost constant supply voltage Uₛ for the controller 110 and may prevent the controller 110 from switching on and off due to small fluctuations of the terminal voltage U_{ind}. In some examples, the voltage converter may be to suppress fluctuations faster than 20 kHz, in one example faster than 1 kHz, by at least 3 dB, in one example by at least 10 dB.

The control circuit 100 comprises a switchable braking circuit 116 that is connected to the motor terminals 106A, 106B. The braking circuit 116 may e.g. be an electrically conducting connection between the terminals 106A, 106B or may be an electrically conducting connection between at least one of the terminals 106A, 106B and a reference point, e.g. a ground contact. The braking circuit 116 may include a switch 118 that is to open or close the braking circuit 116. The switch 118 may for example be a transistor or an electromechanical relay. In some examples, closing the switch 118 may short-circuit the terminals 106A and 106B with each other or with the reference point. A resistance of the braking circuit 116 may e.g. be less than 10 Ω, in some examples less than 1 Ω. In other examples, the braking circuit 116 may comprise additional elements like a resistor, e.g. to dissipate energy.

The controller 110 may be to activate the braking circuit if the terminal voltage U_{ind} at the motor terminals 106A, 106B exceeds a threshold voltage while the controller is in an off-state. For this, the controller 110 may for example control the switch 118. When the switch 118 is closed, the terminal voltage U_{ind} may induce an electric braking current in the braking circuit 116. The braking current can dissipate energy, e.g. due to the electrical resistance of the coils 104 and/or of the braking circuit 116, and can generate a braking force on the electric motor 102. This may reduce the terminal voltage U_{ind} and may prevent the terminal voltage U_{ind} from increasing beyond the threshold voltage. The threshold voltage is a predefined value for the terminal voltage U_{ind} at which the braking circuit is to be activated, e.g. a value that the terminal voltage U_{ind} should not exceed to prevent damage to electronic components connected to the terminal 106A, 106B. The threshold voltage may for example be chosen to be a certain fraction, e.g. between 75% and 90%, of a specified maximum operating voltage of electronic components connected to the terminals 106A, 106B or a certain fraction, e.g. between 125% and 175%, of a regular operating voltage of electronic components connected to the terminals 106A, 106B. Thereby, the voltage applied to electronic components connected to the terminals 106A, 106B may be limited and damage due to an overvoltage may be avoided.

In one example, the electronic components connected to the terminals 106A, 106B may be specified to withstand voltages of up to 42 V and the threshold voltage may be in a range between 30 V and 40 V, e.g. 35 V. In another example, the electronic components connected to the terminals 106A, 106B may have a regular operating voltage of 12 V and the threshold voltage may be in a range between 15 V and 20 V, e.g. 18 V. Since the supply voltage Uₛ for the controller 110 is generated from the terminal voltage U_{ind}, the controller 110 may activate the braking circuit without an external power supply or if the external power supply is switched off. The control circuit 100 may thus provide an overvoltage protection even if a device that the control circuit 100 is used in, e.g. a printing device, is disconnected from power, wherein the voltage to be limited, i.e. the terminal voltage U_{ind}, is used to power the controller, which may then activate the braking circuit to prevent the terminal voltage U_{ind} from exceeding the threshold voltage.

In some examples, the voltage converter 114 may convert the terminal voltage U_{ind} to the supply voltage Uₛ such that the supply voltage Uₛ reaches the minimum supply voltage when the terminal voltage U_{ind} reaches the threshold voltage. Accordingly, the controller 110 is switched on if the terminal voltage U_{ind} exceeds the threshold voltage. The controller 110 may close the switch 118 whenever the controller 110 is switched on and may open the switch whenever the controller is switched off. In other examples, the voltage converter 114 converts the terminal voltage U_{ind} to the supply voltage Uₛ such that the supply voltage Uₛ reaches the minimum supply voltage before the terminal voltage U_{ind} reaches the threshold voltage. The controller 110 may for example monitor the supply voltage Uₛ or the terminal voltage U_{ind} to determine whether the terminal voltage U_{ind} exceeds the threshold voltage and activate the switch 118 in response, e.g. as described below with reference to FIGS. 5a-5c. In some examples, the voltage converter 114 may comprise a voltage divider, e.g. to adjust the terminal voltage U_{ind} at which the controller 110 is switched on.

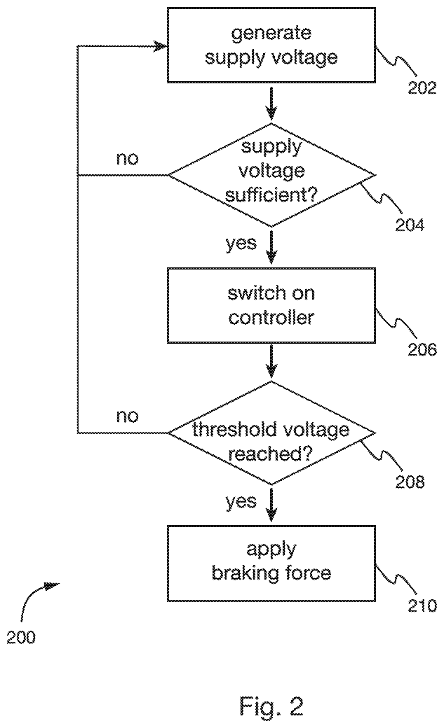

FIG. 2 shows a flow chart of a method 200 of overvoltage protection for an electric motor having a controller according to an example. The method 200 may for example be implemented for the electric motor 102 using the control circuit 100 as described in the following. This is, however, not intended to be limiting and the method 200 may be implemented using any other electric motor with a suitable controller. The flow diagram shown in FIG. 2 does not imply a certain order of execution for the method 200. As far as technically feasible, the method 200 may be performed in any order and different parts may be performed simultaneously at least in part.

The controller 110 is initially in an off-state, e.g. after disconnecting or switching off an external power supply connected to the supply voltage input 112. Accordingly, the supply voltage Uₛ at the supply voltage input 112 may be below a minimum supply voltage and may e.g. be 0 V prior to execution of the method 200. The electric motor 102 may initially be at rest, e.g. because a motor driver for the motor 102 has been switched off.

At 202, a supply voltage Uₛ for the controller 110 is generated from a voltage at the electric motor 102, e.g. the voltage U_{ind} at the terminals 106A, 106B. As described above, the terminal voltage U_{ind} may for example be induced by a rotation of the motor 102, e.g. when manually rotating the motor 102. In the control circuit 100, for example, the supply voltage Uₛ is generated through the voltage converter 114. Generating the supply voltage Uₛ may comprise rectifying and smoothing the voltage U_{ind} at the motor 102, e.g. with the voltage converter 114.

If the supply voltage Uₛ exceeds the minimum supply voltage of the controller 110 at 204, the controller 110 is switched on at 206. Otherwise the controller 110 remains in the off-state. After the controller 110 is switched on, the controller 110 may for example monitor the supply voltage Uₛ or the voltage U_{ind} at the motor 102 to determine, in 208, whether the terminal voltage U_{ind} at the motor 102 exceeds the threshold voltage. If the terminal voltage U_{ind} exceeds the threshold voltage, the method proceeds to 210. In other examples, the supply voltage Uₛ may reach the minimum supply voltage when the terminal voltage U_{ind} reaches the threshold voltage. The controller 110 may then be switched on when the terminal voltage U_{ind} reaches the threshold voltage and the method may directly proceed to 210.

If the voltage at the electric motor 102 exceeds the threshold voltage at 208, a braking force is applied to the electric motor 102 using the controller 110 in 210. Applying the braking force may comprise short-circuiting terminals of the electric motor. In the example shown in FIG. 1, the braking force may be applied by closing the switch 118 to activate the braking circuit 116. As described above, this may lead to a braking current through the braking circuit 116, which generates the braking force. Additionally or alternatively, the braking force may be applied in other ways, for example mechanically using a brake shoe or by generating an electric driving signal to actively decelerate the motor 102. Due to the applied braking force, the terminal voltage U_{ind} may decrease and accordingly, the supply voltage Uₛ may decrease as well. The supply voltage Uₛ may e.g. decrease below the minimum supply voltage such that the controller 110 may switch off again.

FIG. 3 shows a control circuit 300 for the electric motor 102 in accordance with another example, wherein the controller 110 is a motor driver 302 that is to generate an electric driving signal for the electric motor, e.g. a driving voltage at the terminals 106A and 106B. The driving voltage may be adapted to the type of the electric motor 102, e.g. a DC voltage for a brushed DC motor, a commutated DC voltage for a brushless DC motor or an AC voltage for an AC motor. The motor driver 302 may for example generate the electric driving signal by controlling or modulating an input voltage, e.g. supplied by a power supply (not shown in FIG. 3) at an input port 304. For this, the motor driver 302 may control a switching circuit connecting the input port 304 to the terminals 106A, 106B, e.g. an H bridge 306 as detailed below. The motor driver 302 may also be coupled to the power supply to provide an analog or digital signal, e.g. to control an amplitude of a voltage applied to the input port 304 and thereby an amplitude of the driving voltage at the terminals 106A and 106B. In other examples, the motor driver 302 itself may supply the input voltage or the driving voltage. As described above for the controller 110, the motor driver 302 may have a supply voltage input 112 to receive a supply voltage Uₛ powering the motor driver 302. In some examples, the supply voltage input 112 may be connected with the input port 304 to use the input voltage as a supply voltage U.

In the example shown in FIG. 3, the control circuit 300 comprises an H bridge 306 coupled to the terminals 106A and 106B. The H bridge 306 may consist of a low side 308 and a high side 310, each of which may comprise a pair of switches 308A, 308B and 310A, 310B, respectively. The low side may connect the terminals 106A and 106B to a reference point, e.g. a ground contact 312. The high side may connect the terminals 106A and 106B to the input port 304. The motor driver 302 may control the switches 308A, 308B, 310A, 310B to generate the electric driving signal. If the motor 102 is a brushed DC motor, the motor driver 302 may set the polarity of the driving voltage and thereby the direction of rotation of the motor 102 using the H bridge 306, e.g. by closing switch 310A to connect terminal 106A with the input port 304 and closing switch 308B to connect terminal 106B to the ground contact 312. If the motor 102 is a brushless DC motor, the motor driver 302 may use the H bridge 306 to commutate a DC voltage supplied at the input port 304 to generate an appropriate driving voltage.

The H bridge 306 may form at least a part of the voltage converter 114. In the example shown in FIG. 3, the voltage converter 114 is formed by the high side 310 of the H bridge 306, which is connected to the supply voltage input 112. The high side 310 comprises two diodes 314A and 314B, which are connected in parallel with the switches 310A and 310B, respectively. The diodes 314A, 314B may e.g. be arranged such that the forward direction of the diodes 314A, 314B is in the direction from the respective terminal 106A, 106B to the supply voltage input 112, i.e. such that a positive voltage is passed on to the supply voltage input 112 whereas a negative voltage is blocked by the diodes 314A, 314B. The diodes 314A, 314B may in particular be parasitic structures of the switches 310A and 310B, respectively, e.g. a parasitic body diode formed by a transistor. The voltage converter 114 may additionally comprise other switching elements, a smoothing circuit or a voltage divider, e.g. between the high side 310 and the supply voltage input 112. The H bridge 306 may include additional diodes, e.g. additional diodes 315A, 315B connected in parallel with the switches 308A and 308B in the low side 308. Additional diodes 315A, 315B may for example be oriented such that a terminal is grounded via ground contact 312 when the terminal is at a negative voltage relative to the ground contact 312. The additional diodes 315A, 315B may also be parasitic structures of the switches 308A and 308B, respectively.

The H bridge 306 may also form at least a part of the braking circuit 116. In one example, the low side 308 may form the braking circuit 116. Accordingly, the motor driver 302 may activate the braking circuit 116 by closing the switches 308A and 308B, thereby creating an electrically conducting connection between the terminals 106A and 106B. In other examples, the braking circuit 116 may be formed by the H bridge 306 and a switchable circuit connecting the high side 310 to the low side 308. The motor driver 302 may then activate the braking circuit 116 for example by closing the switchable circuit as well as the switches 308A and 310B or by closing the switchable circuit as well as the switches 308B and 310A. The switchable circuit connecting the high side 310 to the low side 308 may for example comprise a resistor to dissipate energy.

The motor driver 302 may further comprise a control input 316 to receive an analog or digital control signal. The control signal may for example characterize a target speed of the motor 102. In one example, the motor driver 302 uses pulse width modulation (PWM) of the driving signal, e.g. via the H bridge 306, to control the speed of the motor 102. The control signal may e.g. determine a duty cycle of the PWM. In another example, the motor driver 302 may set an amplitude of the driving voltage to control the motor speed and the control signal may determine the amplitude of the driving voltage.

The motor driver 302 may also have an enable input 318 to receive an enable signal, e.g. a digital enable signal or an analog enable voltage Uₑ. In some examples, the motor driver 302 may have different states when switched on and the enable signal may determine the state of the motor driver 302. The motor driver 302 may for example switch between a sleep state and an on-state based on the enable signal. Additionally or alternatively, the state of the motor driver 302 may depend on the control signal.

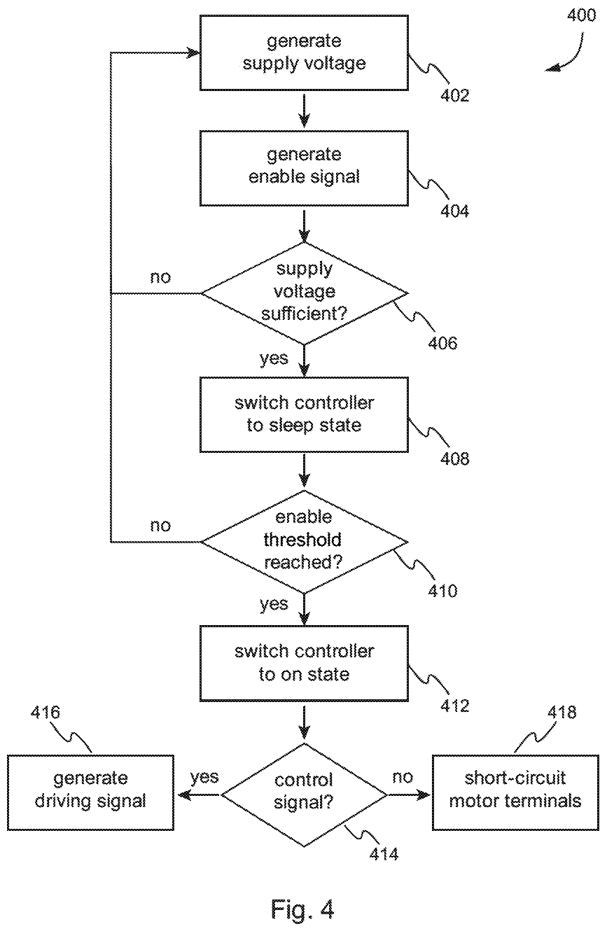

In one example, the motor driver 302 uses a DC voltage equal to or larger than a minimum supply voltage to operate. The motor driver 302 may be in an off-state if the supply voltage Uₛ is below a minimum supply voltage and the control signal is off. In the off-state, the switches 308A, 308B, 310A, 310B may e.g. be open. If the supply voltage Uₛ is equal to or larger than the minimum supply voltage, the motor driver 302 may switch on and enter a state that depends on the enable voltage Uₑ and the control voltage. If the enable voltage Uₑ is below an enable threshold, the motor driver 302 may enter a sleep state, wherein the switches 308A, 308B, 310A, 310B may e.g. remain open. If the enable voltage Uₑ is above the enable threshold, the motor driver 302 may enter an on-state. If the motor driver 302 receives a control signal in the on-state, the motor driver 302 may e.g. enter a drive state, in which the motor driver 302 generates a driving signal for the motor 102 depending on the control signal. If the motor driver 302 does not receive a control signal in the on-state, the motor driver 302 may activate the braking circuit 116. This is described in more detail below with reference to FIGS. 4 and 5a-5c.

If the control signal is an analog control voltage, not receiving a control signal may for example refer to the control voltage being below a minimum level, e.g. less than 0.5 V. In other examples, the motor driver 302 may enter a monitoring state if the supply voltage Uₛ is at or above a minimum supply voltage or if the motor driver 302 does not receive a control signal in the on-state. In the monitoring state, the motor driver 302 may monitor the terminal voltage U_{ind}, e.g. via the supply voltage Uₛ or the enable voltage Uₑ, and may activate the braking circuit 116 if the terminal voltage U_{ind} exceeds the threshold voltage.

The control circuit 300 may comprise a voltage divider circuit 320 to generate an enable signal for the motor driver 302 from the voltage U_{ind} at the motor terminals 106A, 106B, e.g. to convert the terminal voltage U_{ind} to an enable voltage Uₑ. The voltage divider circuit 320 may for example comprise a pair of resistors 320A, 320B connected in series between an input of the voltage divider circuit 320 and a reference point, e.g. a ground contact 322. An output of the voltage divider circuit 320 may be connected to a point between the resistors 320A, 320B. Additionally or alternatively, the voltage divider circuit 320 may comprise other elements, e.g. a rectifier or smoothing circuit. In other examples, the voltage divider circuit 320 may generate a digital enable signal based on the terminal voltage U_{ind}. The voltage divider circuit 320 may either be connected to the terminals 106A, 106B directly or through the voltage converter 114. In the example shown in FIG. 3, the voltage divider circuit 320 is connected to the high side 310 of the H bridge 306, which forms the voltage converter 114. In this example, the voltage divider circuit 320 generates the enable voltage Uₑ from the supply voltage Uₛ, wherein the enable voltage Uₑ is a certain fraction of the supply voltage Uₛ determined by the resistances of the resistors 320A and 320B.

FIG. 4 depicts a flow chart of a method 400 of overvoltage protection for an electric motor according to an example. The method 400 may for example be implemented for the electric motor 102 using the control circuit 300 as described in the following. This is, however, not intended to be limiting and the method 400 may be implemented using any other electric motor with a suitable controller. The flow diagram shown in FIG. 4 does not imply a certain order of execution for the method 400. As far as technically feasible, the method 400 may be performed in any order and different parts may be performed simultaneously at least in part.

Similar to method 200, the method 400 is executed with the motor driver 302 initially in the off-state, e.g. after disconnecting or switching off an external power supply connected to the input port 304. Accordingly, the electric motor 102 may initially be at rest. Furthermore, no control signal may be present at the control input 316, e.g. the control voltage at the control input 316 may be 0 V.

At 402, a supply voltage Uₛ for the motor driver 302 is generated from a voltage at the electric motor 102, e.g. the voltage U_{ind} at the terminals 106A, 106B. As described above, the terminal voltage U_{ind} may for example be induced by a rotation of the motor 102, e.g. when manually rotating the motor 102. Generating the supply voltage Uₛ may comprise rectifying and smoothing the voltage at the motor 102. In the control circuit 300, the supply voltage Uₛ is generated through the voltage converter 114 formed by the high side 310 of the H bridge 306. The diodes 314A and 314B rectify the terminal voltage to generate the supply voltage Uₛ with a predefined polarity. In some examples, the supply voltage Uₛ may be equal to or approximately equal to the modulus of the terminal voltage. This may e.g. be the case when the low side 308 of the H-bridge 306 comprises the additional diodes 315A, 315B connected in parallel to the switches 308A, 308B, wherein the additional diodes 315A, 315B are oriented such that a terminal is grounded via ground contact 312 when the terminal is at a negative voltage relative to the ground contact 312. In other examples, the supply voltage Uₛ may be equal to or approximately equal to a moving average of the modulus of the terminal voltage.

At 404, an enable signal for the motor driver 302 may be generated from a voltage at the electric motor 102, e.g. the voltage U_{ind} at the terminals 106A, 106B. As described above, the enable signal may be an analog enable voltage Uₑ or a digital enable signal. Generating an enable voltage Uₑ may comprise rectifying and smoothing the voltage at the motor 102. In some examples, the enable voltage Uₑ may be generated from the supply voltage Uₛ, e.g. as in the control circuit 300 through the voltage divider circuit 320. Accordingly, the enable voltage Uₑ may be equal to or approximately equal to a fraction of the supply voltage Uₛ. In other examples, the supply voltage Uₛ may be equal to or approximately equal to a fraction of the modulus of the terminal voltage U_{ind} or of a moving average of the modulus of the terminal voltage U_{ind}.

To switch on, the motor driver 302 may for example require a DC voltage equal to or larger than a minimum supply voltage. The motor driver may thus remain in the off-state as long as the supply voltage Uₛ is below the minimum supply voltage at 406. If the supply voltage Uₛ is at or above the minimum supply voltage, the motor driver 302 may be switched on. Switching on the motor driver 302 may comprise switching the motor driver 302 to the sleep state if the supply voltage Uₛ is above the minimum supply voltage and the enable signal is below the enable threshold, and switching the motor driver 302 to the on-state if the supply voltage Uₛ is above the minimum supply voltage and the enable signal is above the enable threshold. The control circuit 300 may be designed such that the motor driver is switched on before the voltage at the electric motor reaches the threshold voltage, e.g. as described below with reference to FIGS. 5a-5c. This may e.g. be helpful to reduce the time that the motor driver 302 needs to activate the braking circuit 116. If the supply voltage Uₛ subsequently drops below the minimum supply voltage, the motor driver 302 may switch off again.

In the example shown in FIG. 4, the motor driver 302 enters the sleep state in 408 if the supply voltage Uₛ is sufficient. In other examples, the motor driver 302 may directly enter different states depending on the enable signal or the control signal as described above. In the sleep state, the motor driver 302 may monitor the enable signal in 410 and may switch to a different state depending on the enable signal. If the enable signal is larger than the enable threshold, the motor driver 302 may switch to the on-state in 412. In the on-state, the motor driver 302 may monitor the control signal in 414. If the motor driver 302 receives a control signal, the motor driver 302 may enter the drive state in 416 and drive the motor 102 by generating an electric driving signal as described above. If the motor driver 302 does not receive a control signal, the motor driver 302 may apply a braking force to the motor 102 in 418, e.g. by closing the switches 308A and 308B to activate the braking circuit 116. The control circuit 300 may be designed such that the enable signal reaches the enable threshold when the voltage at the electric motor reaches the threshold voltage, e.g. as described in the following with reference to FIGS. 5a-5c. In some examples, the motor driver 302 may monitor the terminal voltage U_{ind} in the drive state and may also apply a braking force to the motor 102 if the terminal voltage U_{ind} exceeds the threshold voltage while the motor driver 302 is in the drive state.

FIGS. 5a-5c illustrate an example how the control circuit 300 and the method 400 may be used to protect motor electronics from an overvoltage. FIG. 5a depicts a diagram 500 of the angular velocity ω of the electric motor 102 as a function of time in this example. In FIG. 5b, the corresponding diagram 504 of the terminal voltage U_{ind} over time is shown. FIG. 5c illustrates the corresponding state of the motor driver 302. For comparison, the dashed lines 502 and 506 show an example without overvoltage protection.

Initially, the motor driver 302 is switched off and the motor 102 is at rest (ω=0). In this case, no voltage is induced between the terminals 106A and 106B and U_{ind}=0. As described above, the switches 308A, 308B, 310A and 310B may be open when the motor driver 302 is switched off. Subsequently, the motor 102 is accelerated to a constant angular velocity, e.g. by a user manually rotating the motor 102 or an element mechanically coupled to the motor 102. The rotation of the motor 102 induces a voltage between the terminals 106A and 106B, which depends on the angular velocity, and thus U_{ind}≠0. In some examples, the induced voltage U_{ind} may be proportional or approximately proportional to the angular velocity, i.e. a DC voltage may be generated at a constant angular velocity. In other examples, U_{ind} may change over time and may e.g. exhibit ripples or oscillations, for example if the motor 102 comprises a small number of coils 104 or is a brushless DC motor or an AC motor.

As described above with reference to FIG. 4, the supply voltage Uₛ generated from the terminal voltage U_{ind} by the voltage converter 114 may be equal to or approximately equal to the modulus of the terminal voltage U_{ind} in some examples. In other examples, the supply voltage Uₛ may be smaller than the modulus of the terminal voltage U_{ind}, e.g. due to a voltage drop at the diodes 314A and 314B or other elements of the voltage converter. In addition, the supply voltage Uₛ may be smoothed e.g. using a low-pass filter as detailed above and may for example correspond to a moving average of the terminal voltage U_{ind}.

For the control circuit 300, the enable voltage Uₑ generated from the terminal voltage U_{ind} by the voltage divider circuit 320 may be equal to or approximately equal to a fraction of the supply voltage Uₛ, wherein the fraction depends on the resistances of the resistors 320A and 320B. In one example, the enable voltage Uₑ is one sixth of the supply voltage Uₛ, e.g. by choosing the resistance of the resistor 320A to be five times the resistance of the resistor 320B.

In the example shown in FIGS. 5a-5c, the supply voltage Uₛ is equal to the minimum supply voltage of the motor driver 302 when the terminal voltage U_{ind} is equal to a voltage Uₒ. At this point, the enable voltage Uₑ may be below the enable threshold. Accordingly, the motor driver 302 is switched on when U_{ind} exceeds Uₒ and enters the sleep state. The minimum supply voltage may for example be 5 V and may be equal to Uₒ as described above. As described above, the switches 308A, 308B, 310A and 310B may remain open when the motor driver 302 is in the sleep state.

Subsequently, the motor 102 is accelerated further and the angular velocity increases again. The resistances of the resistors 320A and 320B may be chosen such that the enable voltage Uₑ reaches the enable threshold when the terminal voltage U_{ind} reaches the threshold voltage Uₜ. The enable threshold may e.g. also be 5 V and thus, if the enable voltage Uₑ is one sixth of the supply voltage Uₛ and the supply voltage Uₛ is equal to the modulus of the terminal voltage U_{ind}, Uₜ may for example be 30 V. The threshold voltage Uₜ may be chosen to be smaller than a critical voltage U_{c}, at which electronic components connected to the terminals 106A and 106B may be damaged. The critical voltage may for example be 42 V. As soon as the terminal voltage U_{ind} is larger than Uₜ, the motor driver 302 switches from the sleep state to the on-state. If the motor driver 302 determines that no control signal is applied to the control input 316, the motor driver 302 may short-circuit the terminals 106A and 106B by activating the breaking circuit 116, e.g. by closing the switches 308A and 308B. In this example, the terminal voltage U_{ind} induces a current through the low side 308 of the H bridge 306, which may prevent the terminal voltage U_{ind} from rising further. The current generates a braking force on the motor 102, e.g. due to the rotation of the current-carrying coils 104 in a magnetic field created by magnets in the motor 102, and thus brakes the motor 102. Hence, the angular velocity and the terminal voltage U_{ind} decrease.

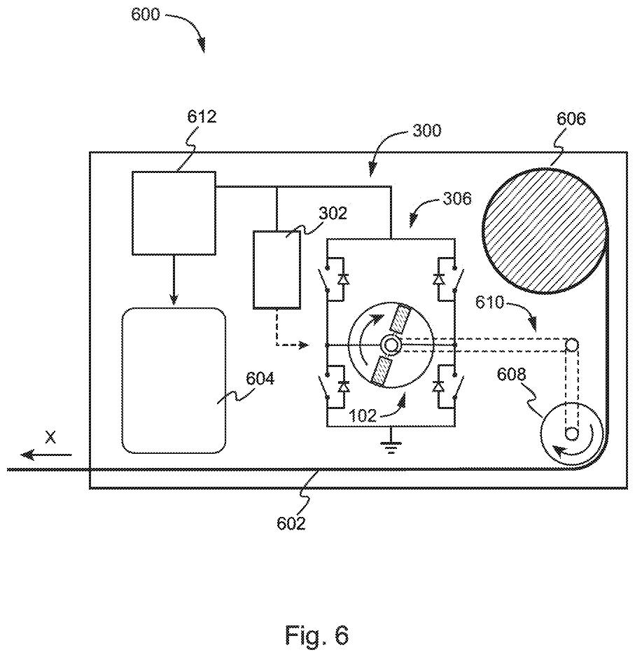

As a result of the decreasing terminal voltage U_{ind}, the enable voltage Uₑ decreases as well. As soon as the enable voltage Uₑ drops below the enable threshold, the motor driver 302 returns to the sleep state and opens the switches 308A and 308B, thereby interrupting the current through the low side 308. The motor 102 may then accelerate again, e.g. if a user continues to manually rotate the motor 102. The motor 102 may thus accelerate again until U_{ind} exceeds Uₜ, at which point the motor driver 302 enters the on-state again and brakes the motor 102. This process may repeat as long as the motor 102 is accelerated manually, leading to a repeated activation of the braking circuit 116 similar to cadence or stutter braking as depicted in FIGS. 5a-5c. The repeated activation of the braking circuit 116 may also serve as a feedback to the user to indicate that the motor 102 is rotated too rapidly as detailed below with reference to FIG. 6. In this way, the control circuit 300 may prevent the terminal voltage U_{ind} from reaching the critical voltage U_{c} and may protect electronic components connected to the terminals 106A and 106B from damage due to overvoltage. Without overvoltage protection, the motor 102 may accelerate further and the terminal voltage U_{ind} may exceed the critical voltage as illustrated by the dashed lines 502 and 506.

FIG. 6 illustrates a sectional view of a printing device 600 according to an example. The printing device 600 may e.g. be a large format printer that is to print on a print medium 602 like paper by depositing a printing substance such as ink using a print head 604. The printing device 600 comprises an electric motor 102 to drive a movable part of the printing device 600. The electric motor 102 may for example be used to advance the print medium 602 along a media advance direction indicated by the arrow labeled “X”. In other examples, the electric motor 102 may be used to move the print head 604 or other parts of the printing device 600, e.g. a maintenance cartridge or a movable cover or door of the printing device 600. The print medium 602 may be rolled up on a supply roll 606. The electric motor may be mechanically coupled to a roll 608, e.g. through a gear drive or belt drive 610, to advance the print medium 602 from the supply roll 606 to a printing area adjacent to the print head 604. Alternatively or additionally, the electric motor 102 may be mechanically coupled to the supply roll 606. The printing device 600 may also comprise a power supply 612, e.g. to generate an input voltage for the motor 102, the print head 604 and other components of the printing device 600.

When the print medium 602 is moved by means other than the motor 102, e.g. by a user manually pulling on an end portion of the print medium 602 extending outside of the printing device 600, the motor 102 may be rotated, e.g. through the roll 608 and the drive 610. As detailed above, this may induce a voltage at terminals of the motor, which may be harmful to electronic components within the printing device 600, e.g. a motor driver like the motor driver 302. If the printing device 600 is switched on, the printing device 600 may monitor the terminal voltage U_{ind}, e.g. through the motor driver 302, and may prevent the terminal voltage U_{ind} from reaching a critical level. However, this may also occur while the printing device 600 is switched off or disconnected from power, i.e. in a state, in which no input voltage is provided by the power supply 612 and the printing device 600 may thus not monitor the terminal voltage U_{ind}.

The printing device 600 therefore comprises a control circuit that is to apply a braking force to the electric motor 102 if a voltage U_{ind} at terminals of the electric motor 102 exceeds a threshold voltage while the printing device is switched off, wherein the control circuit is powered by the voltage U_{ind} at the motor terminals while the printing device is switched off. The control circuit may for example be to apply the braking force by creating an electrically conducting connection between the motor terminals.

The control circuit may e.g. be similar to the control circuit 100 and may comprise a controller 110, a voltage converter 114 and a switchable braking circuit 116 connected to the motor terminals 106A and 106B. The voltage converter may generate a supply voltage Uₛ for the controller 110 from the voltage U_{ind} at the terminals 106A and 106B of the motor 102 and the controller 110 may activate the braking circuit 116 if the voltage U_{ind} at the motor terminals exceeds a threshold voltage while the printing device 600 is switched off, i.e. while the controller 110 is in an off-state.

In the example shown in FIG. 6, the control circuit is the control circuit 300 described above with reference to FIG. 3. In other examples, the control circuit may be similar to the control circuit 300. The control circuit 300 may apply the braking force by creating an electrically conducting connection between the motor terminals 106A and 106B using the H bridge 306. The input port 304 of the control circuit 300 may for example be connected to the power supply 612, e.g. to provide a supply voltage Uₛ for the motor driver 302 and to generate the driving voltage for the motor 102 when the printing device 600 is switched on. In some examples, the ground contacts 312 and 322 may be connected to ground via the power supply 612. The control input and the enable input 318 of the motor driver 302 may be connected to other components of the printing device 600, e.g. a main controller that is to generate the respective signals.

The threshold voltage, above which the control circuit 300 applies the braking force, may for example be adjusted by adjusting the voltage divider circuit 320 (not shown in FIG. 6), e.g. by changing the resistances of the resistors 320A and 320B. Thereby, the ratio between the supply voltage Uₛ and the enable voltage Uₑ and thus the terminal voltage U_{ind} at which the enable voltage Uₑ reaches the enable threshold may be set. In another example, the voltage converter 114 may comprise a voltage divider that determines a ratio between the terminal voltage U_{ind} and the supply voltage Uₛ which may be adjusted. In some examples, the motor driver 302 may be programmable and may e.g. allow for changing the enable threshold.

The threshold voltage may be chosen such that the control circuit 300 provides protection against overvoltage damage and facilitates operation of the printing device 600. As described above, the threshold voltage may be lower than a voltage amount which would damage electronic components connected to the motor terminals 106A, 106B. The threshold voltage may be higher than a voltage that is induced at the motor terminals 106A, 106B when pulling the print medium with a “normal” speed, e.g. with a speed at which a user typically pulls the print medium 602 out of the printing device 600. The “normal” speed may for example be between 0.1 m/s and 0.5 m/s. Thereby, a user may slowly move the print medium 602 without the control circuit 300 interfering, but the control circuit 300 may apply the braking force if the user pulls too fast, inducing a higher voltage in the motor, such that electronic components might be damaged. The braking force may be noticeable by the user as an increased friction or resistance, e.g. when a stutter-like braking force is applied as depicted in FIGS. 5a-5c, and thus may serve as a feedback to the user to indicate that the print medium 602 is moved too fast. The printing device 600 may comprise additional feedback mechanisms, e.g. a warning light or an acoustic alarm, that are to be activated when the terminal voltage U_{ind} exceeds the threshold voltage.

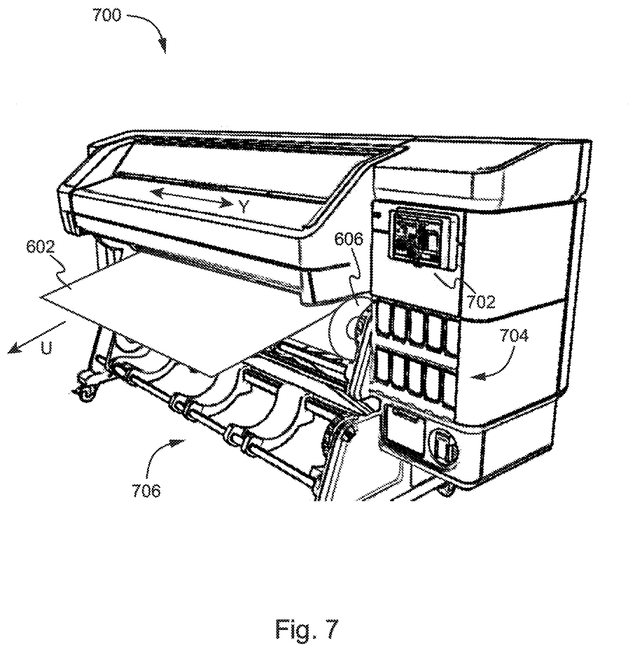

FIG. 7 depicts a perspective view of a printing device 700 in accordance with an example. The printing device 700 may be similar to the printing device 600. The printing device 700 may for example also comprise an electric motor 102 (not shown in FIG. 7) to advance a print medium 602 stored on a supply roll 606 as well as a motor driver 302 (not shown in FIG. 7) to generate an electric driving signal for the electric motor 102. The printing device 700 may further comprise a print head 604 (not shown in FIG. 7) that is movable along a direction “Y” that may e.g. be perpendicular to the media advance direction “X” in order to deposit a printing substance on the print medium 602. The printing device 700 may also comprise a control panel 702 for controlling the printing device 700, e.g. to adjust printer settings or to initiate execution of a printing job, and a plurality of cartridges 704, e.g. to supply a plurality of printing substances, e.g. ink of different colors.

The printing device 700 may include a supply compartment 706 to mount the supply roll 606 containing an unused part of the print medium 602. The supply roll 606 may be removably attached to the printing device 700, e.g. via mounting pins or clips, such that the supply roll 606 is accessible and may be exchanged by a user. When mounted, the supply roll 606 may be coupled to the electric motor 102, e.g. via the mounting pins, such that the electric motor 102 can rotate the supply roll 606 to advance the print medium 602. An end portion of the print medium 602 may be accessible to a user and a user may manually pull on the end portion as indicated by the arrow labeled “U”, e.g. to insert the end portion of the print medium 602 into the printing device 700 for printing. The user may thereby accelerate the electric motor 102, e.g. while the printing device 700 is switched off. To avoid motor electronics being damaged by the induced voltage, the motor driver 302 provides an overvoltage protection by applying a braking force to the electric motor 102 as described above. In particular, the motor driver 302 may not apply the braking force if the print medium 602 is pulled with a “normal” speed such that a user can unroll the print medium 602 from the supply roll 606. In contrast, if the print medium 602 is pulled rapidly, thereby inducing a potentially damaging voltage, the motor driver 302 may apply the braking force, which may be noticeable by the user as an increased friction.

This description is not intended to be exhaustive or limiting to any of the examples described above. The electric motor control circuit, the printing device, and the method of overvoltage protection disclosed herein can be implemented in various ways and with many modifications without altering the underlying basic properties.

1. An electric motor control circuit, the control circuit comprising:
a controller;
a voltage converter to generate a supply voltage of the controller from a voltage at terminals of the electric motor; and
a switchable braking circuit connected to the motor terminals,
wherein the controller is to activate the braking circuit if the voltage at the motor terminals exceeds a threshold voltage while the controller is in an off-state.

2. The control circuit of claim 1, wherein the controller is a motor driver that is to generate an electric driving signal for the electric motor.

3. The control circuit of claim 2, wherein the voltage converter comprises a rectifier between a supply voltage input of the motor driver and the motor terminals.

4. The control circuit of claim 3, further comprising an H bridge coupled to the motor terminals, wherein a high side of the H bridge forms at least a part of the voltage converter.

5. The control circuit of claim 1, wherein the braking circuit includes a switch to short-circuit the motor terminals.

6. The control circuit of claim 2, wherein the motor driver comprises a control input to receive a control signal characterizing a target speed of the electric motor, wherein the motor driver is in an off-state if the supply voltage is below a minimum supply voltage and the control signal is off.

7. The control circuit of claim 6, further comprising a voltage divider circuit to generate an enable signal for the motor driver from the voltage at the motor terminals, wherein:
the motor driver is in a sleep state if the supply voltage is above the minimum supply voltage and the enable signal is below an enable threshold; and
the motor driver is in an on-state if the supply voltage is above the minimum supply voltage and the enable signal is above the enable threshold; and
the motor driver is to activate the braking circuit if the motor driver is in the on-state and the control signal is off.

8. A printing device comprising:
an electric motor to drive a moveable part of the printing device; and
a control circuit to apply a braking force to the electric motor if a voltage at terminals of the electric motor exceeds a threshold voltage while the printing device is switched off,
wherein the control circuit is powered by the voltage at the motor terminals while the printing device is switched off.

9. The printing device of claim 8, wherein the control circuit is to apply the braking force by creating an electrically conducting connection between the motor terminals.

10. The printing device of claim 8, wherein the electric motor is to advance a print medium.

11. A method of overvoltage protection for an electric motor having a controller, wherein the controller initially is in an off-state, the method comprising:
generating a supply voltage for the controller from a voltage at the electric motor;
switching on the controller if the supply voltage exceeds a minimum supply voltage; and
applying a braking force to the electric motor using the controller if the voltage at the electric motor exceeds a threshold voltage.

12. The method of claim 11, wherein applying a braking force to the electric motor comprises short-circuiting terminals of the electric motor.

13. The method of claim 11, wherein the voltage at the electric motor is induced by the electric motor.

14. The method of claim 11, further comprising:
generating an enable signal for the controller from the voltage at the electric motor, wherein the enable signal exceeds an enable threshold of the controller when the voltage at the electric motor exceeds the threshold voltage;
wherein switching on the controller comprises switching the controller to a sleep state if the supply voltage is above the minimum supply voltage and the enable signal is below the enable threshold, and switching the controller to an on-state if the supply voltage is above the minimum supply voltage and the enable signal is above the enable threshold.

15. The method of claim 14, wherein the controller applies the braking force if the controller is switched to the on-state and does not receive a control signal.
